(19) United States
(12) Patent Application Publication
(10) Pub. No.: US 2017/0168808 A1
(43) Pub. Date: Jun. 15, 2017

(54) INFORMATION PROCESSING APPARATUS, METHOD FOR PROCESSING INFORMATION, AND INFORMATION PROCESSING SYSTEM

(71) Applicants: Yuushin KAKEI, Kanagawa (JP); Hiroki OZAKI, Tokyo (JP)

(72) Inventors: Yuushin KAKEI, Kanagawa (JP); Hiroki OZAKI, Tokyo (JP)

(73) Assignee: Ricoh Company, Ltd., Tokyo (JP)

(21) Appl. No.: 15/363,131

(22) Filed: Nov. 29, 2016

(30) Foreign Application Priority Data
Dec. 15, 2015 (JP) 2015-244315

(51) Int. Cl. G06F 9/445; G06F 9/44

(52) U.S. Cl. CPC G06F 8/65; G06F 8/71

(57) ABSTRACT

An information processing apparatus that executes second software capable of communicating with first software running on an information terminal, includes a receiver unit to receive version information of the first software from the information terminal; a function identification unit configured, if a newer version of the first software is obtainable, to refer to function information in which available functions are associated with the version information of the first software and the second software, respectively, so as to obtain first functions available with the first software after a version upgrade to the newer version, and second functions available with a current version information of the second software, and to identify available functions commonly with the first functions and the second functions; and a transmitter unit to transmit the identified available functions to the information terminal.

### BACKGROUND OF THE INVENTION

1. Field of the Invention

The present disclosure relates to an information processing apparatus, a method for processing information, and an information processing system.

2. Description of the Related Art

Electronic whiteboards have been known that have touch panels installed on large flat panel displays. An electronic whiteboard displays a screen having a role of a whiteboard or a blackboard, takes in a trajectory of an electronic pen or a finger via a touch panel, and draws the trajectory on the screen as hand-written content. Therefore, the user can use the screen as a whiteboard or a blackboard.

Also, an electronic whiteboard that can be connected with a personal computer can obtain image data from the personal computer to display a screen with the same image, and can have hand-written content superimposed to be drawn on the screen. Also, the electronic whiteboard can transmit a screen displayed on the touch panel to the personal computer, to display a screen with the same image on the personal computer as on the electronic whiteboard, and can operate on the personal computer following information input on the touch panel. Such cooperation between an electronic whiteboard and a personal computer will be referred to as “image sharing”, and a function for cooperation will be referred to as an “image sharing function”.

To make it possible such cooperation between an electronic whiteboard and a personal computer, software for executing image sharing with the electronic whiteboard may need to be installed on the personal computer. Therefore, if the software is not installed on the personal computer, or if the installed version of the software is old, the user of the personal computer needs to install the software on the personal computer. However, upon the installation, the user may have a desire for knowing in advance which functions become available by installing the software on the personal computer.

To cope with such a desire, a technology has been devised that presents functions of a software program to the user (see, for example, Patent Document 1). Patent Document 1 discloses a method in which a client computer transmits a request for a list of applications downloadable from a server, and a list of functions provided by a host program, and in response to the request, the server sends back a list of applications whose functions are supported, to be displayed on the client.

However, the method described in Patent Document 1 has a problem in that the version of the software installed on an electronic whiteboard is not considered. To execute image sharing and the like between the personal computer and the electronic whiteboard, the electronic whiteboard needs to have the software for the image sharing installed. Since the software programs on the electronic whiteboard and the personal computer need to communicate with each other, functions available on the personal computer may be limited depending on a combination of versions of the software. For example, even if the version of the software on the personal computer is the latest, if the version of the software on the electronic whiteboard is older, functions provided with the latest version of the software may not be available on the personal computer.

In this way, even if the version and functions of the software installed on the client are known, functions available on the personal computer may change depending on the version of the software on the electronic whiteboard as a counterpart of image sharing with the personal computer. Therefore, as described above, there has been a problem in that it has been often the case where functions available on a personal computer cannot be presented to a user if the version of the software installed on an electronic whiteboard is not taken into consideration.

### SUMMARY OF THE INVENTION

According to an embodiment in the present disclosure, an information processing apparatus that executes second software capable of communicating with first software, and communicates with an information terminal that executes the first software, includes a receiver unit configured to receive version information of the first software from the information terminal; a function identification unit configured, in a case where the first software having newer version information exists, that is newer than the first software having the version information received by the receiver unit, to refer to function information in which one or more available functions are associated with the version information of the first software and the second software, respectively, so as to obtain one or more first functions available with the first software after a version upgrade, and one or more second functions available with a current version information of the second software, and to identify available functions commonly with the first functions and the second functions; and a transmitter unit configured to transmit the available functions identified by the function identification unit to the information terminal.

### BRIEF DESCRIPTION OF DRAWINGS

FIGS. 1A-1B are examples of diagrams illustrating general features of an image processing system according to an embodiment in the present disclosure;

FIG. 2 is a configuration diagram of an entire image processing system according to the embodiment;

FIG. 3 is an example of a hardware configuration diagram of an electronic whiteboard;

FIG. 4 is an example of a hardware configuration diagram of a client PC;

FIG. 5 is an example of a diagram schematically illustrating functions of a client PC and an electronic whiteboard included in an image processing system;

FIG. 6 is an example of a detailed functional block diagram of an electronic whiteboard and a client PC;

FIGS. 7A-7B are examples of diagrams illustrating confirmation by an electronic whiteboard about whether a version of client software is appropriate;

FIG. 8 is an example of a diagram illustrating confirmation about whether versions of client software correspond to versions of electronic whiteboard software;

FIG. 9 is an example of a sequence chart illustrating steps for a client PC to start communicating with an electronic whiteboard;

FIGS. 10A-10B are examples of diagrams illustrating functions available for a user that are changed depending on a combination of a version of software on an electronic whiteboard and a version of software on a client PC;

FIG. 11 is an example of a diagram illustrating a method for providing functions to be available by a version upgrade of client software;

FIG. 12 is an example of a flowchart illustrating steps for generating a list of functions;

FIG. 13 is an example of a diagram illustrating an example of presenting a list of functions to be available after a version upgrade;

FIG. 14 is an example of a diagram illustrating a method for obtaining the latest version of client software by an electronic whiteboard;

FIG. 15 is an example of a sequence chart illustrating steps for presenting a list of functions when a client PC communicates with an electronic whiteboard;

FIG. 16 is a flowchart for presenting a list of functions available with the current version of the client software, in addition to a list of functions to be available with the latest version; and

FIGS. 17A-17B are examples of diagrams illustrating lists of functions displayed by a client PC.

### DETAILED DESCRIPTION OF THE EMBODIMENTS

In the following, embodiments will be described with reference to the drawings. An information processing apparatus will be described that can present functions to be available with software operating on an information terminal, to a user.

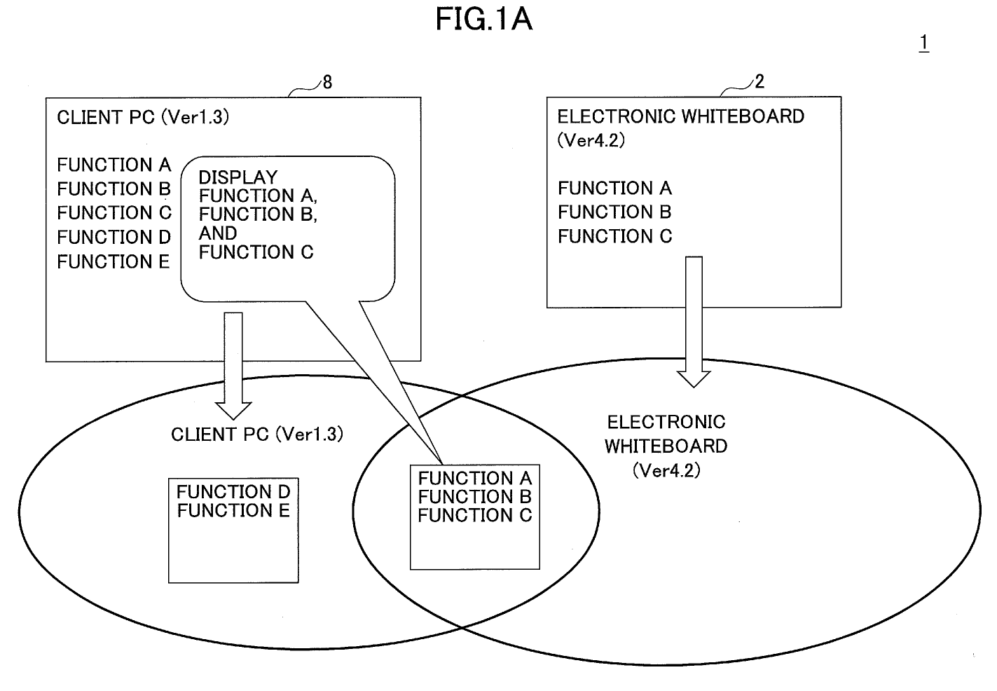

FIGS. 1A-1B are examples of diagrams illustrating general features of an image processing system according to an embodiment in the present disclosure. FIG. 1A illustrates a case in which a user is considering to install Version 1.3 of a software application on a client PC 8 (referred to as “client software”, below). Also, Version 4.2 of another software application runs on an electronic whiteboard 2 (referred to as “electronic whiteboard software”, below). Version 1.3 of the client software includes functions A to E, and Version 4.2 of the electronic whiteboard software includes the functions A to C.

In this case, the client PC 8 provides the functions A to C for the user, which are common functions of the functions A to E of the client software, and the functions A to C of the electronic whiteboard software (displays the functions on a display device of the client PC 8).

FIG. 1B illustrates a case in which a user is considering to install Version 1.3 of the client software. Version 4.3 of the electronic whiteboard software runs on the electronic whiteboard 2. Version 1.3 of the client software includes the functions A to E, and Version 4.3 of the electronic whiteboard software includes the functions A to E.

In this case, the client PC 8 provides the functions A to E for the user, which are common functions of the functions A to E of the client software, and the functions A to E of the electronic whiteboard software (displays the functions on the display device of the client PC 8).

Therefore, the image processing system 1 in the embodiment can display not only functions available with the client software, but also functions to be available with a new version of the client software to be installed, taking the functions provided by the electronic whiteboard software into account.

<About Terms>

The client software runs on the client PC 8, and the electronic whiteboard software runs on the electronic whiteboard 2. The client software and the electronic whiteboard software are created to be capable of sharing images.

The image sharing here refers to sharing images by the client PC 8 and the electronic whiteboard 2. Also, the image sharing includes accompanying functions. Specifically, the electronic whiteboard may receive image data displayed by the client PC 8 on the screen, to display the image on its own display. Also, the client PC 8 may receive image data displayed by the electronic whiteboard on the screen, to display the image on its own display. Also, the electronic whiteboard may transmit a user operation on the display to the client PC 8, to execute an operation on the client PC 8. However, functions of the image sharing are not limited to these.

Here, “software” means procedures about operations of a computer, and information to be processed. A program is a type of what-is-called “software”. Software and programs may not need to be distinguished strictly. Software is information commanding functions to be implemented on the electronic whiteboard 2 or the client PC 8 in a language that can be decoded by a computer, and may be considered as information about functional command description. Such information may be specifically referred to as an application program, firmware, or an OS (Operating System), but not limited to these.

Also, a version (or version information) means one of different versions of the same software in which functions may be improved, and/or defects may be corrected.

<Overview of System>

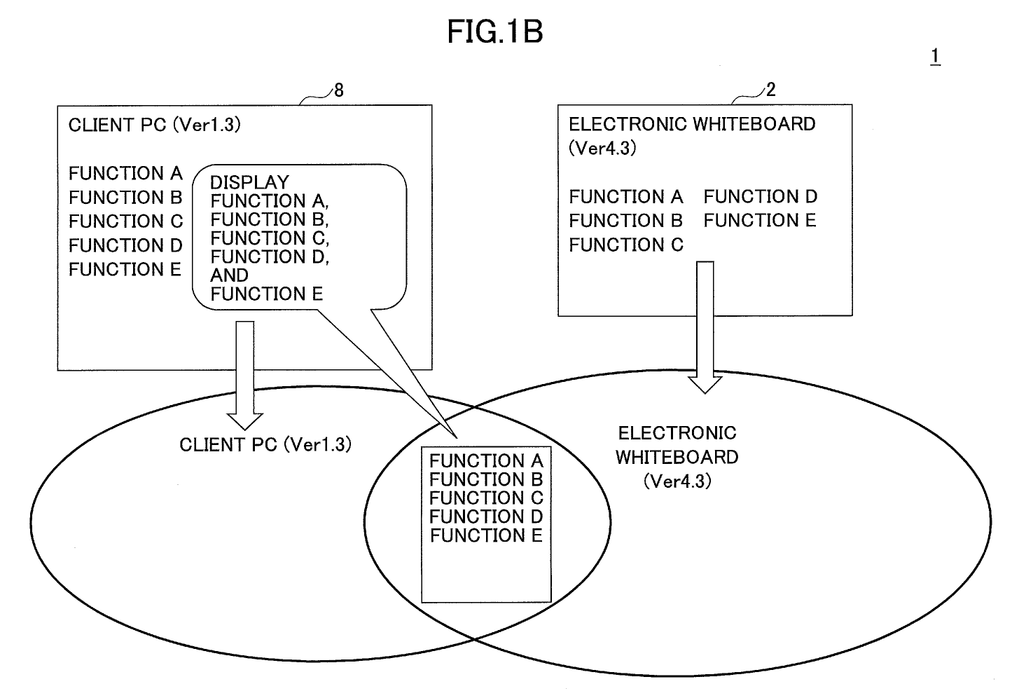

FIG. 2 is a configuration diagram of the entire image processing system 1 according to the embodiment. Note that in FIG. 2, just two units of the electronic whiteboards 2a and 2b, accompanying electronic pens 4a and 4b, and the like are illustrated to simplify the description. However, three or more units of the electronic whiteboards 2, the electronic pens, and the like may be used. As illustrated in FIG. 2, the image processing system 1 includes the electronic whiteboards 2a and 2b, the electronic pens 4a and 4b, USB memories 5a and 5b, note PCs (Personal Computers) 6a and 6b, video-conference terminals 7a and 7b, and the client PC 8. Also, the electronic whiteboards 2a and 2b, and the client PC 8 are connected via a communication network 9 to communicate with each other. Furthermore, the electronic whiteboards 2a and 2b are provided with displays 3a and 3b, respectively.

Also, the electronic whiteboard 2a can have the display 3a display an image drawn by events generated by the electronic pen 4a (touches on the display 3a by the pen point of the electronic pen 4a or the pen tail of the electronic pen 4a). Note that the image displayed on the display 3a can be changed based on events generated by not only the electronic pen 4a, but also a user's hand Ha or the like (gestures for magnification, reduction, page turning, and the like).

Also, the USB memory 5a can be connected with the electronic whiteboard 2a so that the electronic whiteboard 2a can read an electronic file such as a PDF from the USB memory 5a, and the electronic whiteboard 2a can record an electronic file on the USB memory 5a. Also, a note PC 6a is connected with the electronic whiteboard 2a via a cable 10a1 that is capable of communication by standards such as Display Port (trademark), DVI (Digital Visual Interface), HDMI (High-Definition Multimedia Interface, trademark), VGA (Video Graphics Array), etc. Then, when an event is generated by a contact on the display 3a, the electronic whiteboard 2a transmits event information representing the event to the note PC 6a in the same way as done for events on an input unit such as a mouse and a keyboard. Similarly, the video-conference terminal 7a is connected with the electronic whiteboard 2a via a cable 10a2 that is capable of communication by the standards. Note that the note PC 6a and the video-conference terminal 7a may communicate with the electronic whiteboard 2a via wireless communication compliant with various wireless communication protocols such as Bluetooth (trademark).

At another site where the electronic whiteboard 2b is installed, the electronic whiteboard 2b having the display 3b, the electronic pen 4b, the USB memory 5b, the note PC 6b, the video-conference terminal 7b, a cable 10b1, and a cable 10b2 are used similarly as above. In addition, an image displayed on the display 3b can be changed based on events generated by a user's hand Hb or the like.

Thus, an image drawn on the display 3a of the electronic whiteboard 2a at the one site is displayed on the display 3b of the electronic whiteboard 2b at the other site. Conversely, an image drawn on the display 3b of the electronic whiteboard 2b at the other site is displayed on the display 3a of the electronic whiteboard 2a at the one site. In this way, a remote sharing process for sharing the same image at remote locations can be executed with the image processing system 1. Therefore, by using the system, for example, a conference between remote locations can be held very conveniently.

Note that in the following, an arbitrary one of the electronic whiteboards will be referred to as an “electronic whiteboard 2”. An arbitrary one of the displays will be referred to as a “display 3”. An arbitrary one of the electronic pens will be referred to as an “electronic pen 4”. An arbitrary one of the USB memories will be referred to as a “USB memory 5”. An arbitrary one of the note PCs will be referred to as a “note PC 6”. An arbitrary one of the video-conference terminals will be referred to as a “video-conference terminal 7”. Also, an arbitrary one of the hands of users will be referred to as a “hand H”. An arbitrary one of the cables will be referred to as a “cable 10”. Also, although an electronic whiteboard will be described in the embodiment as an example of an image processing apparatus, the image processing apparatus is not limited to that; another examples of the image processing apparatus include an electronic signboard (a digital signage), a telestrator used for sports and weather forecast, and a remote image (video) diagnostic device. Also, although the note PC 6 will be described as an example of an information processing terminal, the information processing terminal is not limited to that; another examples of the information processing terminal include a desktop PC, a tablet PC, a PDA, a digital video camera, a digital camera, a game machine, and any other terminals with which an image frame can be provided. Further, the communication network includes the Internet, a LAN (Local Area Network), and a cellular phone communication network. Also, although the USB memory 5 will be described as an example of a recording medium, the recording medium is not limited to that; other examples of the recording medium include an SD card and various recording media.

The client PC 8 is an information processing terminal that shares images with the electronic whiteboard 2. The client PC 8 corresponds to one of the various types of information terminals having the client software installed. Alternatively, the client PC 8 may be an information terminal having browser software installed. If browser software runs on the client PC 8, the version is less likely to be a restricting factor because an image is displayed following a standard such as HTML. Therefore, the client software is more favorable for description of the embodiment, but the embodiment is also applicable to the browser software.

Also, a projector and the video-conference terminal 7 may be considered as the client PC 8. These devices have software (or firmware) installed that is virtually equivalent to the client software.

As an information terminal having the client software installed, for example, a tablet terminal, a smart phone, a PC, a PDA (Personal Digital Assistant), a wearable PC, a game machine, a cellular phone, a car navigation system, or the like may be considered. However, the terminal is not limited to these.

<Hardware Configuration of Electronic Whiteboard>

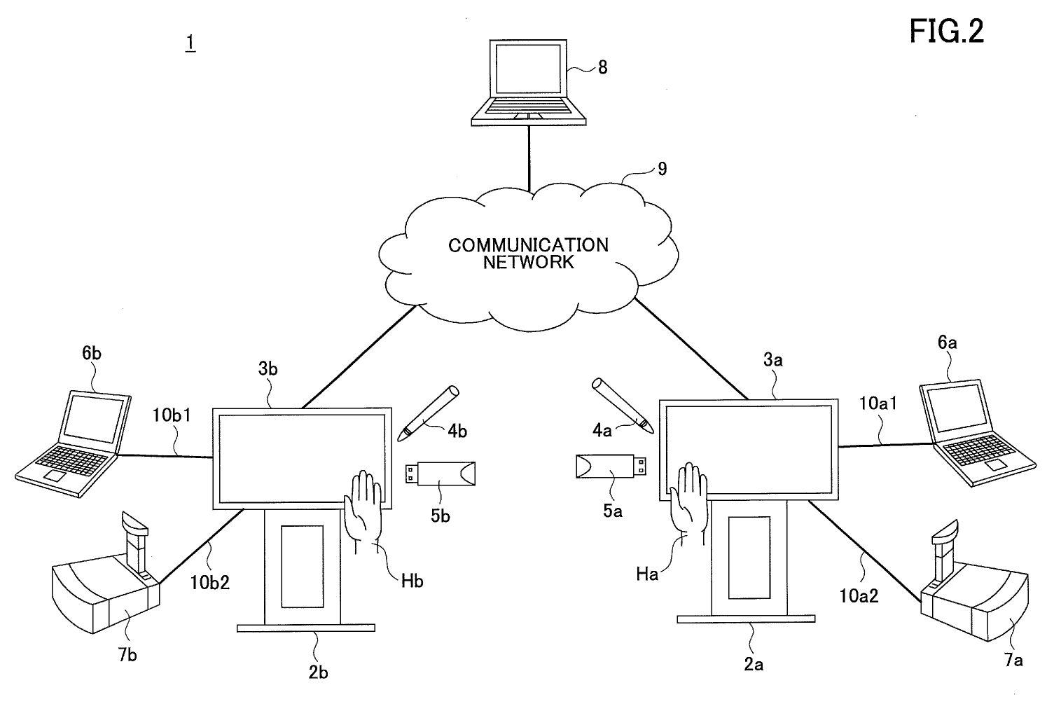

Next, by using FIG. 3, a hardware configuration of the electronic whiteboard 2 will be described according to the embodiment. Note that FIG. 3 is an example of a hardware configuration diagram of the electronic whiteboard 2.

As illustrated in FIG. 3, the electronic whiteboard 2 includes a CPU 101 to control the overall behavior of the electronic whiteboard 2; a ROM 102 to store programs to be used for driving the CPU 101, such as an IPL (Initial Program Loader); a RAM 103 used as a work area for the CPU 101; an SSD (Solid State Drive) 104 to store various data items of a program for an electronic whiteboard (electronic whiteboard software); a network controller 105 to control communication with the communication network 9; and an external storage controller 106 to control communication with the USB memory 5.

The electronic whiteboard 2 also includes a capturing device 111 to capture a still picture or a moving picture that is displayed on a display of the note PC 6; a GPU (Graphics Processing Unit) 112 dedicated to processing graphics; and a display controller 113 to control and manage a screen display to output an image output from the GPU 112 to the display 3 and the video-conference terminal 7.

The electronic whiteboard 2 further includes a sensor controller 114 to control a process of a touch sensor 115; and the touch sensor 115 to detect a contact of the electronic pen 4 or the user's hand H on the display 3. This touch sensor 115 receives coordinates as input by an infrared cut-off method, and detects the coordinates. This method of inputting coordinates and detecting coordinates is a method in which two light reception/emission devices disposed at both ends on the upper side of the display 3, emit multiple infrared rays parallel to the display 3, and receive the light that is reflected by a reflecting member disposed around the display 3, and comes back through the same light path as the light emitted by light reception elements has gone through. The touch sensor 115 outputs IDs (Identifications) of the infrared rays that have been emitted by the two light reception/emission devices, and cut off by an object, to the sensor controller 114, and the sensor controller 114 identifies a coordinate position which is a contact position of the object. Note that all IDs described in the following are examples of identification information.

The touch sensor 115 is not limited to such an infrared cut-off method, but various detection units may be used including a touch panel of an electrostatic capacitance type that identifies a contact position by detecting a change of the electrostatic capacitance; a touch panel of a resistance film method to identify a contact position by a voltage change of two resistor films facing each other; and a touch panel of an electromagnetic induction type to identify a contact position by detecting electromagnetic induction generated by a contact object contacting a display unit 31.

The electronic whiteboard 2 also includes an electronic pen controller 116. This electronic pen controller 116 communicates with the electronic pen 4, to determine whether there is a touch by the pen point or a touch by the pen tail on the display 3. Note that the electronic pen controller 116 may determine whether there is a touch not only by the pen point or the pen tail, but also by a part of the electronic pen 4 gripped by the user, or another part of the electronic pen.

The electronic whiteboard 2 further includes a bus line 120 including an address bus, a data bus, and the like to electrically connect the CPU 101, the ROM 102, the RAM 103, the SSD 104, the network controller 105, the external storage controller 106, the capturing device 111, the GPU 112, the sensor controller 114, and the electronic pen controller 116 as illustrated in FIG. 3.

Note that the electronic whiteboard software may be recorded on recording media readable by computers such as CD-ROMs to be distributed.

<<Hardware Configuration of Client Terminal>>

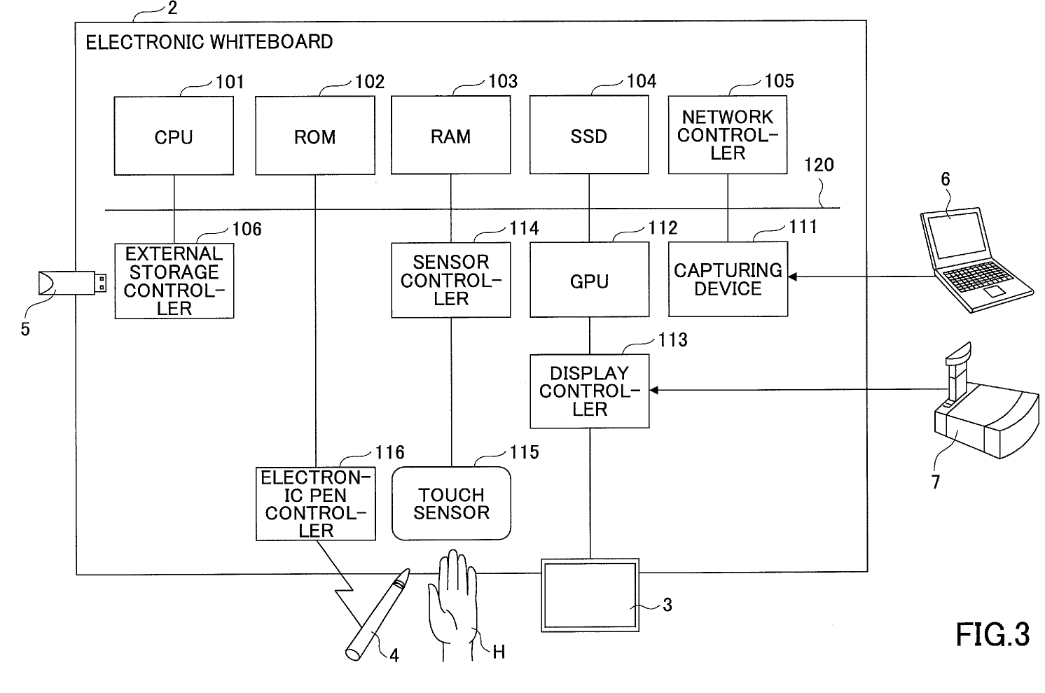

FIG. 4 is an example of a hardware configuration diagram of the client PC 8. As illustrated, the client PC 8 includes functions of an information processing apparatus. The client PC 8 includes a CPU 201, a RAM 202, an input device 203, an external I/F 204, a camera 205, an SSD 206, a ROM 207, a display device 208, a wireless communication device 209, an NFC communication device 210, a BL module 211, and a cellular phone communication device 212, which are mutually connected by a bus B.

The CPU 201 implements control and functions of the client PC 8 as a whole, by reading the programs and data into the RAM 202 from a storage device such as the ROM 207 and the SSD 206, and executing processes. The RAM 202 is an example of a volatile semiconductor memory (a storage device) to store programs and data temporarily.

The input device 203 includes, for example, a keyboard and a touch panel that are used by the user to input operational signals. Note that the input device 203 may include a mouse pointer and an audio input device.

The external I/F 204 is an interface with an external device. An example of the external device is a recording medium 204a. The recording medium 204a can store the client software that implements functions of the embodiment. The client PC 8 can execute a read and a write on the recording medium 204a via the external I/F 204.

The recording medium 204a is, for example, an SD memory card. The recording medium 204a may be a USB memory (Universal Serial Bus memory), a DVD (Digital Versatile Disk), a CD (Compact Disk), a flexible disk, or the like.

The camera 205 is an imaging unit that includes a lens to form an image, an aperture stop, and an imaging element such as CMOS and CCD. The camera 205 can capture not only a still picture but also moving pictures.

The SSD 206 is a non-volatile storage device to store programs and data. The stored programs and data include an OS that is basic software to control the client PC 8 as a whole, and the client software that provides various functions on the OS. Note that the client PC 8 may include an HDD (Hard Disk Drive) instead of the SSD 206, or together with the SSD 206.

The ROM 207 is a non-volatile semiconductor memory (a storage device) that can hold programs and data even when the power is turned off. The ROM 207 stores a BIOS (Basic Input/Output System) that is executed when activating the client PC 8, and programs and data for OS settings and network settings.

The display device 208 is, for example, a flat panel display such as an LCD (Liquid Crystal Display) and an organic EL display, to display a processed result by the client PC 8. It is preferable that the display device 208 includes a touch panel.

The wireless communication device 209 is an interface to execute wireless communication, to communicate with the electronic whiteboard 2 by a communication protocol, for example, a wireless LAN. Note that communication protocols of the wireless LAN include Wi-Fi Direct, the ad hoc mode, and the infrastructure mode. Any of these communication protocols may be used for the communication.

The NFC communication device 210 executes communication following a communication protocol using an IC chip, for example, NFC or TransferJet (trademark). In other words, the NFC communication device 210 is an RF tag reader/writer.

The BL module 211 is a communication device that executes communication following the communication protocol of Bluetooth (trademark). The cellular phone communication device 212 is a communication device capable of long-distance wireless communication such as LTE (Long Term Evolution) and 3G, and can make a connection with a cellular phone network.

<Functions of Image Processing System>

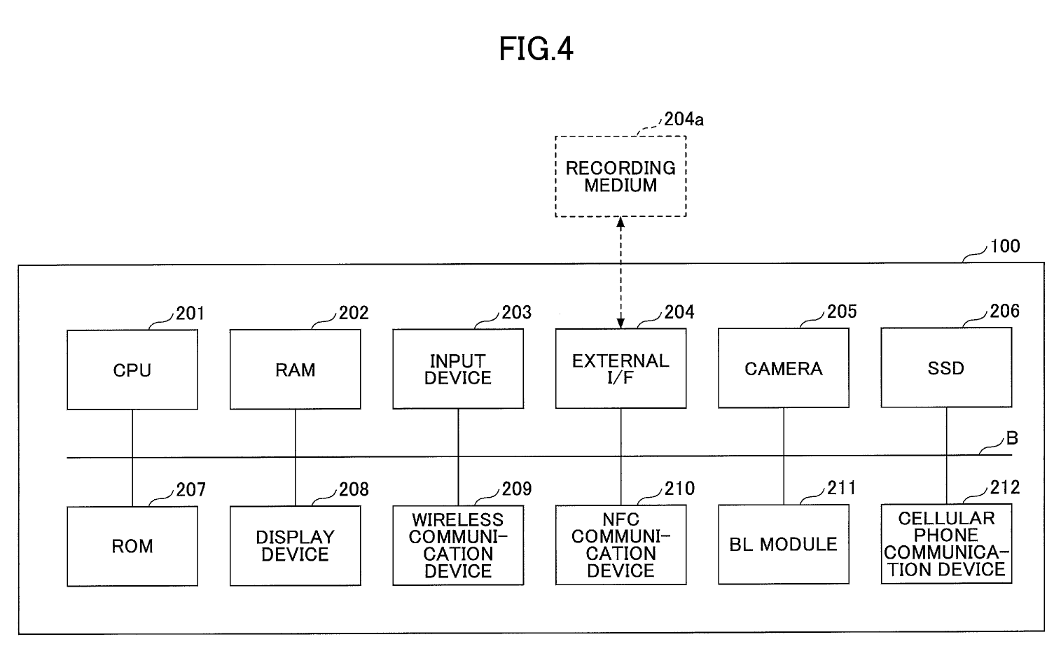

FIG. 5 is an example of a diagram schematically illustrating functions of the client PC 8 and the electronic whiteboard 2 included in the image processing system 1.

As illustrated in FIG. 2, the electronic whiteboard 2 and the client PC 8 can communicate with each other via the communication network 9. Considering confidentiality of a conference, the communication network 9 is preferably an intranet with which the security is assured, but may be the Internet as described above. Also, the electronic whiteboard 2 and the client PC 8 may communicate with each other through a one-to-one connection. Specifically, the electronic whiteboard 2 and the client PC 8 may be connected by a USB cable or a HDMI (trademark) cable, or may communicate by a wireless LAN such as the ad hoc mode.

A whiteboard application 20 and a video distribution service 40 run on the electronic whiteboard 2. At least one of the whiteboard application 20 and the video distribution service 40 constitutes the electronic whiteboard software. Versions of the electronic whiteboard software are defined as described above. Versions of the client software are also defined as described above.

Image sharing functions of the electronic whiteboard 2 and the client PC 8 can be used only if the relationship between versions of the electronic whiteboard software and the client software is appropriate. Even if the image sharing functions can be used, functions may be restricted depending on the versions of the electronic whiteboard software and the client software.

The video distribution service 40 of the electronic whiteboard 2 compresses an image displayed on the display 3 of the electronic whiteboard 2 (referred to as a “whiteboard image 22”, below) into a compressed video 23, and transmits the video to the client PC 8. The whiteboard application 20 of the electronic whiteboard 2 provides functions of the electronic whiteboard 2 that include drawing strokes and receiving operations.

The client PC 8 receives the compressed video 23 from the electronic whiteboard 2, and displays it on the display device 208 in real time. Also, operational information 91 such as strokes and image data 92 displayed on the client PC 8 can be transmitted to the electronic whiteboard 2. By these mechanisms, smooth image sharing and interaction between terminals are realized.

Note that the configuration in FIG. 5 is just an example; multiple units of the client PCs 8 may exist, and multiple units of the electronic whiteboards 2 may exist.

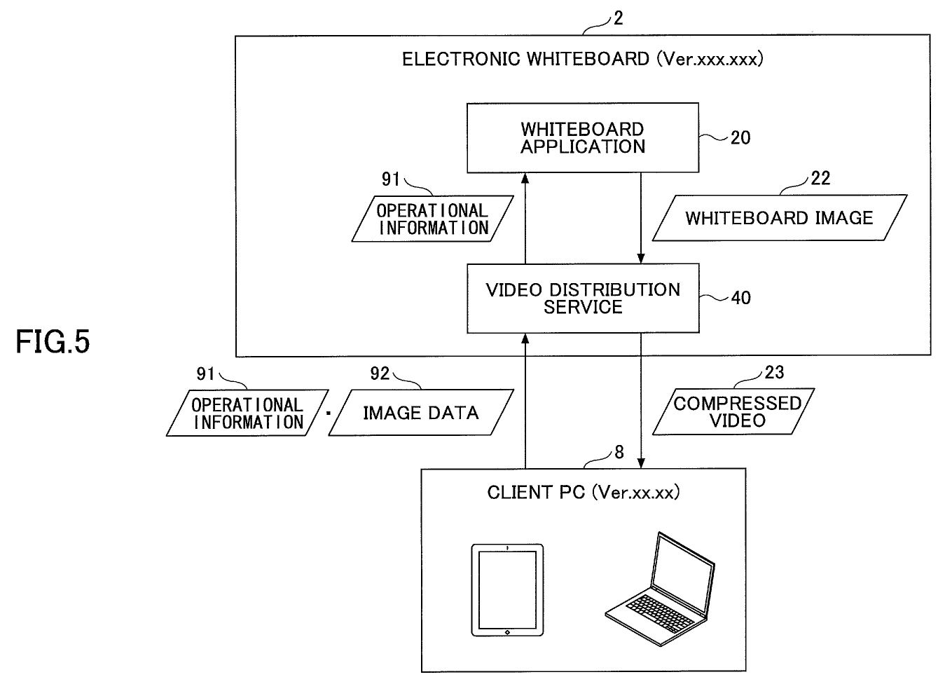

FIG. 6 is an example of a detailed functional block diagram of the electronic whiteboard 2 and the client PC 8. First, functions of the electronic whiteboard 2 will be described.

<<Electronic Whiteboard>>

The whiteboard application 20 and the video distribution service 40 included in the electronic whiteboard 2 are functions implemented by the CPU 101 executing the electronic whiteboard software stored in the SSD 104, to control the elements illustrated in FIG. 3. Note that a part of or all of these functions may be implemented by hardware (an IC circuit and the like).

The electronic whiteboard 2 also includes a storage unit 400 implemented by the SSD 104, the RAM 103, the ROM 102, and the like illustrated in FIG. 3. The storage unit 400 includes a version determination condition storage unit 401 and a function list storage unit 402. First, information stored in the storage unit 400 will be described.

TABLE 1

| | Ver4.1 | Ver4.2 | Ver4.3 | Ver4.4 |
|---|---|---|---|---|
| Ver1.1 | A | A | N/A | N/A |
| Ver1.2 | A | A | N/A | N/A |
| Ver1.3 | A | P/A | P/A | N/A |
| Ver1.4 | N/A | N/A | N/A | A |

Table 1 is an example of a schematic view illustrating version determination conditions stored in the version determination condition storage unit 401. Version determination conditions are registered for respective combinations of a version of the client software and a version of the electronic whiteboard software, and whether the client software corresponds to the electronic whiteboard software is specified for each of the combinations. In the table, “A” represents a correspondence or “Availability”, “P/A” represents a partial correspondence or “Partial Availability”, and “N/A” represents no correspondence or “No Availability”. A method for generating Table 1 will be described later.

The term “correspondence” or “to correspond to” means as follows. A certain version of software A corresponding to a certain version of software B means that the software A operates with the software B properly. For example, whether an application corresponds to an OS is often discussed in terms of the versions. If a version of an application does not correspond to a version of an OS, the application does not operate on the OS properly. Therefore, whether the software A corresponds to the software B may be rephrased that the software A matches with, or is available with the software B.

Note that the electronic whiteboard 2 automatically obtains the version determination conditions from a program distribution server 60, which will be described later. Alternatively, an administrator of the electronic whiteboard 2 may set the conditions on the electronic whiteboard 2.

TABLE 2

| | LIST OF FUNCTIONS |
|---|---|
| Ver1.1 | FUNCTIONS A, B, C |
| Ver1.2 | FUNCTIONS A, B, C, D |
| Ver1.3 | FUNCTIONS A, B, C, D, E |
| Ver1.4 | FUNCTIONS A, B, C, D, E, F |
| Ver4.1 | FUNCTIONS A, B |
| Ver4.2 | FUNCTIONS A, B, C |
| Ver4.3 | FUNCTIONS A, B, C, D, E |
| Ver4.4 | FUNCTIONS A, B, C, D, E, F |

Table 2 is an example of a schematic view illustrating lists of functions stored in the function list storage unit 402. The lists of functions are registered for respective versions of the client software and the electronic whiteboard software, and each of the lists includes functions available in a specific version of the client software or the electronic whiteboard software.

It is assumed here that the latest version of the client software registered in the lists of functions is represented by a version having the greatest numerical value. Thus, the electronic whiteboard 2 can identify the latest version of the client software (in Table 2, Ver1.3 is the latest version).

The electronic whiteboard 2 automatically obtains the lists of functions from the program distribution server 60, which will be described later. Alternatively, an administrator of the electronic whiteboard 2 may set the lists on the electronic whiteboard 2.

The functions A to F are functions for image sharing, and various contents may be included. For example, there may be a function for the electronic whiteboard 2 to receive image data displayed on the screen by the client PC 8, and to display the image on its own display device. Also, there may be a function for the client PC 8 to receive image data of a screen displayed on the display 3 by the electronic whiteboard 2, and to display the image data on a display device of the client PC 8. Also, there may be a function to transmit a user operation on the electronic whiteboard 2 to the client PC 8, to operate the client PC 8. Also, there may be a function added due to change of the UI (User Interface). Also, there may be a function added due to change of the communication protocol. Also, there may be a function added due to change of commands to be transmitted to each other.

(Functions)

First, the whiteboard application 20 includes a display unit 31, a function execution unit 32, an application input/output unit 33, a page generation unit 34, an operation reception unit 35, and a stroke drawing unit 36.

The display unit 31 is implemented by the CPU 101, the GPU 112, the display controller 113, and the like illustrated in FIG. 3, to display a whiteboard image 22 on the display 3. In other words, the display unit synthesizes a whiteboard image 22 from UI images such as strokes handwritten by the user, the image data 92 transmitted by the client PC 8, and menus, to display the synthesized image on the display 3.

The function execution unit 32 is implemented by the CPU 101 and the like illustrated in FIG. 3, to execute various functions. For example, the function execution unit 32 executes various types of image processing such as an OCR process, management of settings of the electronic whiteboard 2, and displaying a guidance message.

The application input/output unit 33 is implemented by the CPU 101 and the like illustrated in FIG. 3, to communicate with the video distribution service 40. Thus, the operational information 91 and the image data 92 transmitted by the client PC 8 can be obtained.

The page generation unit 34 is implemented by the CPU 101 and the like illustrated in FIG. 3, to manage pages where one page corresponds to one screen displayed on the display 3. For example, in response to a user operation, the page generation unit 34 displays a new page, and stores the page on which strokes have been drawn. Also, in response to a user operation, the page generation unit 34 displays the stored page again.

The operation reception unit 35 is implemented by the CPU 101, the touch sensor 115, the electronic pen controller 116, and the like illustrated in FIG. 3, to receive various operations performed by the user.

The stroke drawing unit 36 is implemented by the CPU 101, the touch sensor 115, and the like illustrated in FIG. 3, to obtain a history of coordinates input by the user with a hand H or the electronic pen 4, and to form a stroke from the history of coordinates. This stroke is drawn by the display unit 31.

Next, the video distribution service 40 includes a distribution service input/output unit 41, a distribution module 42, a transceiver unit 43, a capturing unit 44, a codec module 45, a version check unit 46, and a function comparison unit 47.

The distribution service input/output unit 41 is implemented by the CPU 101 and the like in FIG. 3, to execute communication with the whiteboard application 20. Thus, the operational information 91 and the image data 92 transmitted by the client PC 8 are indicated to the whiteboard application 20. The stroke drawing unit 36 draws strokes based on the operational information 91, and the display unit 31 displays the drawings on the display 3. Similarly, the image data 92 received from the client PC 8 is displayed by the page generation unit 34 of the whiteboard application 20, as background of a new page generated by the page generation unit 34.

The distribution module 42 is implemented by the CPU 101 and the like in FIG. 3, to distribute the whiteboard image 22 displayed on the display 3 by the display unit 31 of the whiteboard application 20, to another electronic whiteboard 2 and the client PC 8. Distribution is executed every time the whiteboard image 22 displayed on the display 3 is updated.

The transceiver unit 43 is implemented by the CPU 101, the network controller 105, and the like in FIG. 3. The transceiver unit 43 includes a receiver unit 43a and a transmitter unit 43b. The receiver unit 43a receives the operational information 91 such as strokes and the image data 92 from the client PC 8. The transmitter unit 43b transmits the compressed video 23 to the client PC 8.

The capturing unit 44 is implemented by the CPU 101, the capturing device 111, and the like in FIG. 3, to take in a screen transmitted by the note PC 6, and to generate (capture) the image data 92.

The codec module 45 is implemented by the CPU 101 and the like in FIG. 3, to compress the whiteboard image 22 distributed by the distribution module 42. Thus, communication load between the electronic whiteboard 2 and the client PC 8 can be reduced.

The version check unit 46 is implemented by the CPU 101 and the like in FIG. 3, to confirm versions of the electronic whiteboard software and the client software based on Table 1, in response to receiving a request for connection from the client PC 8, and to determine whether the image sharing is possible.

The function comparison unit 47 is implemented by the CPU 101 and the like in FIG. 3, to generate a list of functions to be available by a version upgrade of the client software.

Configured as described above, it is possible to input information from the client PC 8 to the electronic whiteboard 2, and to distribute a video in real time.

<<Client Terminal>>

The client PC 8 includes a GUI unit 81, a video decoder unit 82, and a communication control unit 83.

The communication control unit 83 is implemented by the CPU 201, the wireless communication device 209, and the like in FIG. 4, to execute communication with the electronic whiteboard 2. The IP address of the electronic whiteboard 2 and the like may be registered in advance in the client software, or may be set by the user. The communication control unit 83 having started communication transmits the version of the client software to the electronic whiteboard 2.

The GUI unit 81 is implemented by the CPU 201, a touch panel formed on the display device 208, the input device 203, and the like in FIG. 4, to receive an operation on the client PC 8. Thus, the operational information 91 such as a stroke is obtained. The communication control unit 83 transmits the operational information 91 to the electronic whiteboard 2. Also, the GUI unit 81 displays a conference material and the like on the display device 208. The displayed conference material becomes the image data 92 to be transmitted to the electronic whiteboard 2. In response to a predetermined operation by the user, or automatically, the communication control unit 83 transmits the image data 92 to the electronic whiteboard 2.

The video decoder unit 82 is implemented by the CPU 201 and the like in FIG. 4, to decode (expand) the compressed video 23 received by the communication control unit 83 from the electronic whiteboard 2. The GUI unit 81 displays the decoded whiteboard image 22 on the display device 208.

Configured as described above, it is possible to transmit information from the client PC 8, and to share images in real time.

<Version Check>

Once the client PC 8 has established a connection with the electronic whiteboard 2, the electronic whiteboard 2 determines whether the image sharing is possible with the client software, based on the versions of the software.

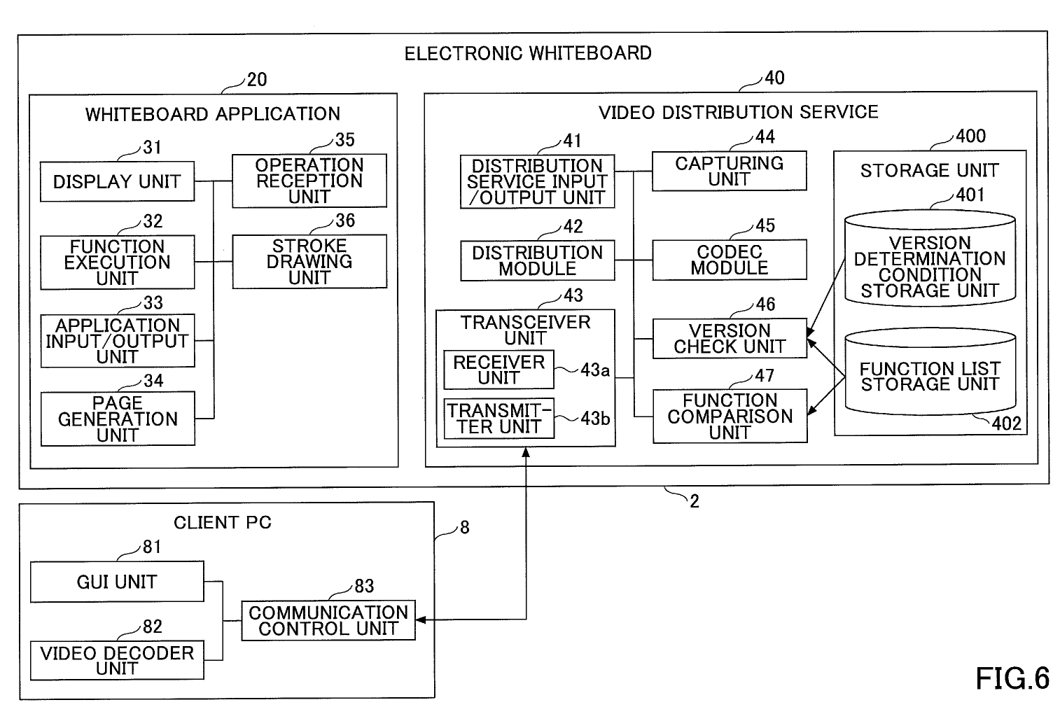

FIGS. 7A-7B are examples of diagrams illustrating confirmation by the electronic whiteboard 2 about whether the version of the client software is appropriate. As illustrated in FIG. 7A, if the version of the client software on the client PC 8 corresponds to the version of the electronic whiteboard software on the electronic whiteboard 2, the electronic whiteboard 2 transmits a message “connection permitted 301” to the client PC 8. In other words, since the version of the client software matches with the version of the electronic whiteboard software, image sharing is possible.

As illustrated in FIG. 7B, if the version of the client software on the client PC 8 does not correspond to the version of the electronic whiteboard software on the electronic whiteboard 2, the electronic whiteboard 2 transmits a message “connection not permitted 302” to the client PC 8. In response to receiving the message “connection inhibited 302”, the GUI unit 81 of the client PC 8 displays an update indication on the display device 208. The update indication is an indication to prompt the user to upgrade (update) the version of the software, specifically, a message as follows. As the update indication, for example, a message such as “please update” is displayed on the display device 208. Thus, the user can grasp that upgrading the version of the client software is required for image sharing.

Note that in case of a partial correspondence (a “P/A” in Table 1), either one of the connection permitted 301 or the connection inhibited 302 may be transmitted. In case of a partial correspondence, and the connection permitted 301 is transmitted, the user may use the image sharing with the electronic whiteboard 2 without an installation. In case of a partial correspondence, and the connection permitted 302 is transmitted, the user can grasp that a version upgrade is required, and functions will be available by the version upgrade.

<<Method for Confirming Version Correspondence>>

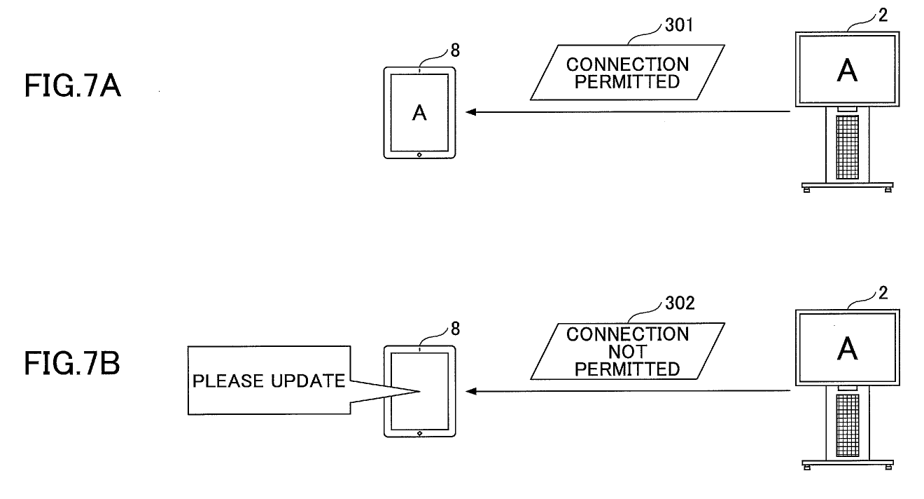

FIG. 8 is an example of a diagram illustrating confirmation about whether versions of the client software correspond to versions of the electronic whiteboard software. In FIG. 8, an example will be described for a case where the version of the software is determined by the UI, versions of commands, and versions of communication protocol. Change or no change of the UI, a version A of a command, and a version B of the communication protocol are represented by (UI changed/unchanged, A, B). Note that the UI means design of the screen. The command is information used by the client software and the electronic whiteboard software to indicate operational content to each other, by a name or a predetermined bit string. The communication protocol is steps of communication in which a flow of transmission and reception of information is specified so that the client software and the electronic whiteboard software can properly transmit and receive the information. Example combinations are:

(UI unchanged, 1, 1)->the version of the client software is 1.1, and the version of the electronic whiteboard software is 4.1;

(UI changed, 1, 1)->the version of the client software is 1.2, and the version of the electronic whiteboard software is 4.2;

(UI unchanged, 2, 1)->the version of the client software is 1.3, and the version of the electronic whiteboard software is 4.3; and

(UI unchanged, 2, 2)->the version of the client software is 1.4, and the version of the electronic whiteboard software is 4.4.

The concept of correspondence between the version of the client software and the version of the electronic whiteboard software can be described as follows. Also, the version determination conditions in Table 1 are generated based on this concept.

Change of the UI does not change the logic of the system, and hence, does not affect or hardly affect the image sharing between the electronic whiteboard 2 and the client PC 8. Therefore, change of the UI does not affect determination about whether the version of the client software corresponds to the version of the electronic whiteboard software.

If the versions of the communication protocol are different, the difference tends to result in a state where the client PC 8 cannot communicate with the electronic whiteboard 2. Therefore, it is determined that the version of the client software does not correspond to the version of the electronic whiteboard software.

Since a command is information that transfers the operational information 91 from the client PC 8 to the electronic whiteboard 2, if the command versions are different, an operational content by the user may be indicated to the electronic whiteboard 2. However, if the command version of the client software is newer than the command version of the electronic whiteboard software, the client software can indicate at least a part of commands to the electronic whiteboard 2. Therefore, even if the command versions are different, and if the command version of the client software is newer than the command version of the electronic whiteboard software, it is exceptionally determined that the version of the client software corresponds to the version of the electronic whiteboard software. Such a correspondence is referred to as a “partial correspondence”.

By determining in this way, for example, even if the command version of the electronic whiteboard 2 is older than the command version of the client PC 8, the user can use the image sharing without upgrading the version on the electronic whiteboard 2.

For example, as illustrated in the lists of functions in Table 2, the client software Version 1.3 having an increased command version number over Version 1.2 has an additional function E. Also, the client software Version 1.2 has an additional function D over Version 1.1 due to change of the UI. Also, although the client software Version 1.3 has additional functions D and E over the electronic whiteboard software Version 4.2, the difference comes from change of the UI and the command version. Therefore, the client software Version 1.3 can communicate with the electronic whiteboard software Version 4.2. Also, assuming that the function C relates to, for example, the UI and the command version, the client software Version 1.3 can communicate with the electronic whiteboard software Version 4.1.

In FIG. 8, versions of the software connected by a solid line represents that the version of the client software corresponds to the version of the electronic whiteboard software. Versions of the software connected by a dotted line represents that the version of the client software partially corresponds to the version of the electronic whiteboard software.

In this way, versions of the corresponding software may form not only one-to-one correspondence (Ver1.4 corresponds to Ver4.4), but also one-to-many correspondence (Ver1.3 corresponds to Ver4.1, 4.2, and 4.3).

<Steps for Confirming Versions>

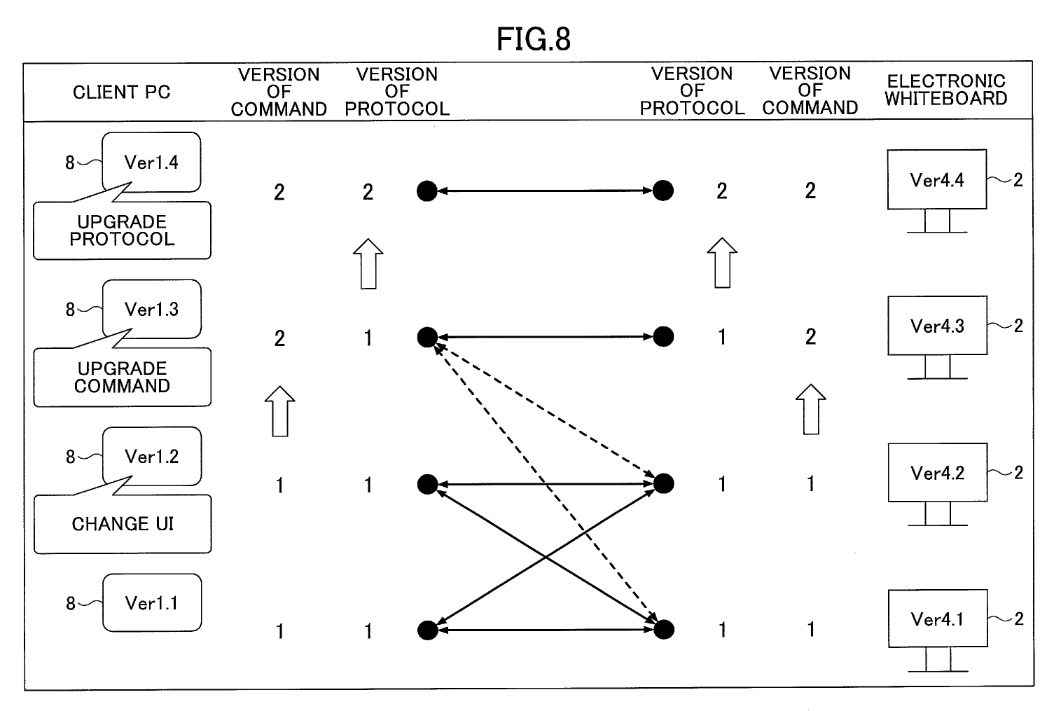

FIG. 9 is an example of a sequence chart illustrating steps for the client PC 8 to start communicating with the electronic whiteboard 2.

Step S1: The user operates on the client PC 8, to select a connection to the electronic whiteboard 2. The GUI unit 81 of the client PC 8 receives the selection of the connection. When the client PC 8 starts connecting to the electronic whiteboard 2, the electronic whiteboard 2 confirms the correspondence of the versions.

Step S2: Having received the selection of the connection, the GUI unit 81 of the client PC 8 indicates the connection request to the communication control unit 83.

Step S3: The communication control unit 83 of the client PC 8 transmits the version of the client software to the electronic whiteboard 2.

Step S4: The receiver unit 43a of the electronic whiteboard 2 receives the version of the client software, and indicates the version to the version check unit 46.

Step S5: The version check unit 46 of the electronic whiteboard 2 confirms whether the version of the client software corresponds to the version of the electronic whiteboard software. In other words, the version check unit 46 reads out the version determination conditions in Table 1, to confirm which one of “A”, “P/A”, and “N/A” is applicable.

Step S6: The version check unit 46 of the electronic whiteboard 2 indicates the confirmed result to the transceiver unit 43.

Step S7: The transmitter unit 43b of the electronic whiteboard 2 transmits the confirmed result to the client PC 8.

Step S8: The communication control unit 83 of the client PC 8 receives the confirmed result, and indicates the result to the GUI unit 81.

Step S9: If the confirmed result is “N/A”, the GUI unit 81 displays an update indication on the display device. If the confirmed result is “A”, the communication control unit 83 starts receiving the compressed video 23 and the like. If the confirmed result is “P/A”, the GUI unit 81 displays an update indication on the display device 208, and the communication control unit 83 starts receiving the compressed video 23 and the like. As the update indication in the case of a partial correspondence, for example, the GUI unit 81 displays a message such that “Although a part of the function is restricted, the image sharing is possible”. Thus, the user may upgrade the version, or may use the image sharing without the version upgrade if the restriction does not matter. If the confirmed result is “N/A”, the GUI unit 81 displays a message, for example, “please update” as in FIG. 8, on the display device 208.

Note that if the image sharing cannot be used due to the version of the electronic whiteboard 2 being older than version of the client PC 8, the version may be upgraded on the electronic whiteboard 2, or a message about the old version may be displayed.

<Combination of Versions of Client Software and Electronic Whiteboard Software>

As has been described already, a certain version of the client software may communicate with different versions of the electronic whiteboard software. On the other hand, since a function not available with the electronic whiteboard 2 cannot be used with the client software, available functions for the user change depending on a combination of the version of the electronic whiteboard 2 and the version of the client PC 8.

A case will be described in which the version of the client software is, for example, Ver1.3. According to the list of functions in the function list storage unit 402, the functions A, B, C, D, and E are available with the client software. However, if the version of the electronic whiteboard software is Ver4.2, only the functions A, B, and C are available with the electronic whiteboard software. Therefore, only the functions A, B, and C are available with the client software.

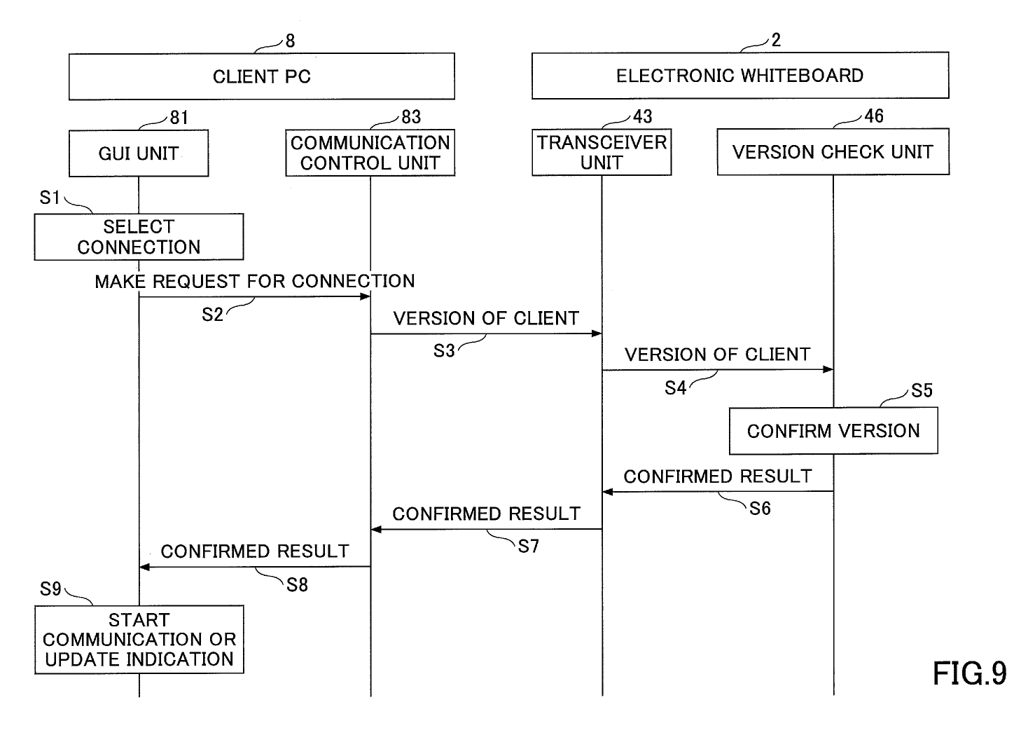

FIG. 10A represents functions available with the client software if the version of the client software is Ver1.3 and the version of the electronic whiteboard software is Ver4.2.

On the other hand, if the version of the electronic whiteboard software is Ver4.3, the functions A, B, C, D, and E are available with the electronic whiteboard software. Therefore, the functions A, B, C, D, and E are available on the client software.

FIG. 10B represents functions available with the client software if the version of the client software is Ver1.3 and the version of the electronic whiteboard software is Ver4.3.

In this way, available functions are not identified with just one of the versions on the electronic whiteboard 2 and the client PC 8. As in FIG. 10, even if the version of the client software is Ver1.3, available functions may be different for different versions of the electronic whiteboard software to be connected with.

Thus, available functions are not uniquely determined depending on a version of the client software to be upgraded, and consequently, there is a problem in that it may be difficult for the user to determine whether to upgrade the version.

<Displaying List of Functions to be Available after Version Upgrade>

Thereupon, the image processing system 1 according to the embodiment provides a list of functions to be available for the user if upgrading the version of the client software.

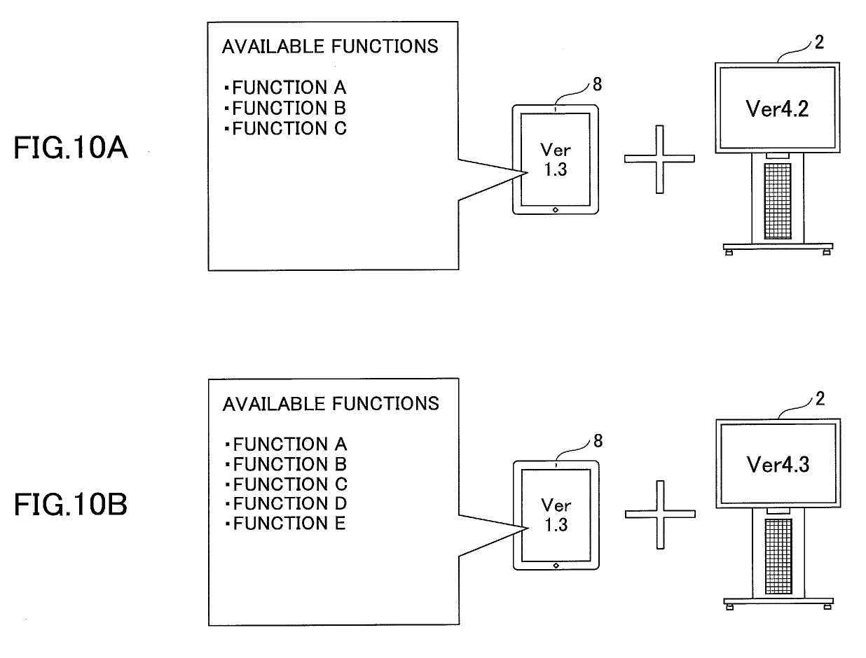

FIG. 11 is an example of a diagram illustrating a method for providing functions to be available by a version upgrade of the client software. The function comparison unit 47 of the electronic whiteboard 2 compares functions between the version of the electronic whiteboard software and the latest version of the client PC 8, to generate the list of functions to be available.

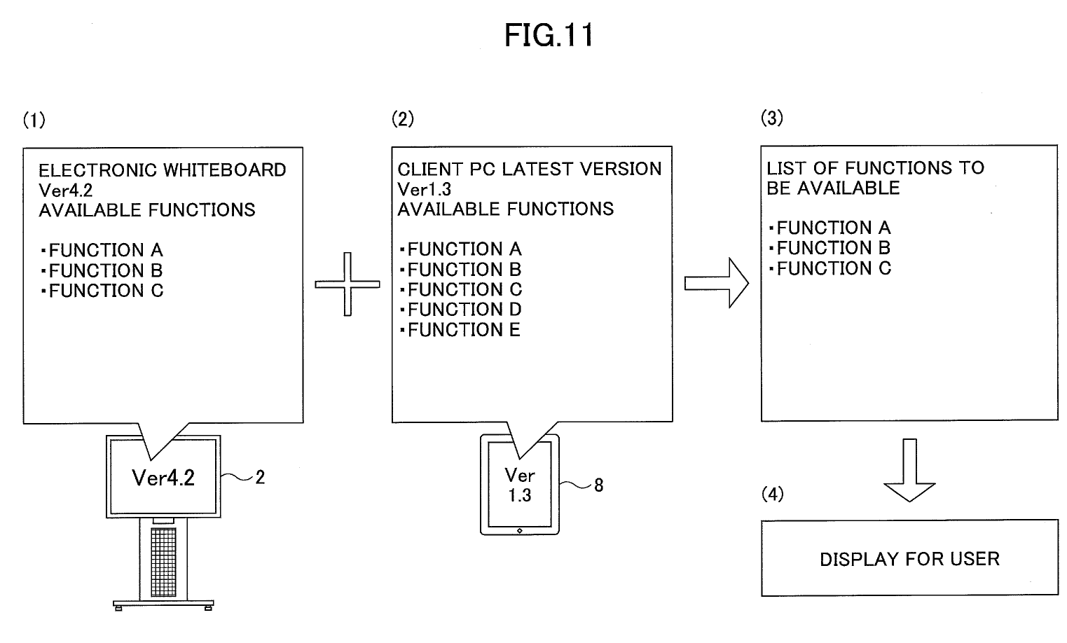

Steps for generating the list of functions are as illustrated in (1) to (3) in FIG. 11. Also, the steps are also illustrated in FIG. 12 by a flowchart. FIG. 12 is an example of the flowchart illustrating steps for generating a list of functions. Assume that the version of the electronic whiteboard software is 4.2, the latest version of the client software is 1.3.

(1) The function comparison unit 47 generates a list of functions available with the current version of the electronic whiteboard software (Step S10). By reading out the list of functions in the function list storage unit 402, functions A, B, and C are turned out to be available functions with the electronic whiteboard software Version 4.2.

(2) The function comparison unit 47 obtains functions available with the latest version of the client software, and generates the list (Step S20). By reading out the list of functions in the function list storage unit 402, functions A, B, C, D, and E are turned out to be available functions with the latest version of the client software 1.3. Here, it is assumed that the latest version of the client software is a version that is the latest among the lists of functions in the function list storage unit 402.

(3) The function comparison unit 47 compares the two lists, and generates a list of functions available with both of the versions (Step S30). Therefore, the functions A, B, and C are listed. These functions make up the list of functions available when upgrading the version of the client software (an example of available functions).

(4) The GUI unit 81 of the client PC 8 displays the list of functions available when upgrading the version of the client software.

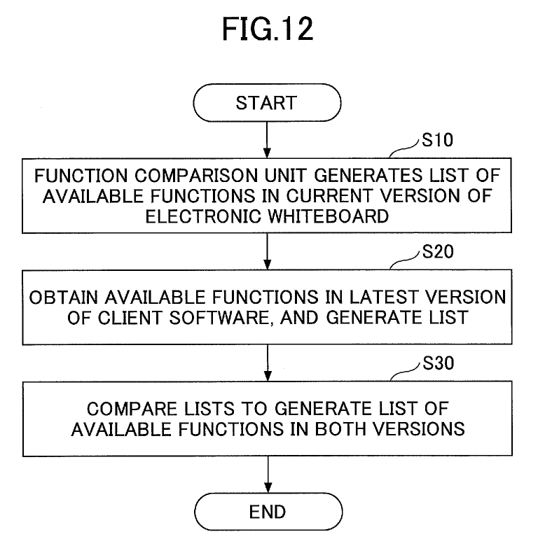

FIG. 13 is an example of a diagram illustrating an example of presenting a list of functions to be available after a version upgrade. The function comparison unit 47 of the electronic whiteboard 2 transmits a list of functions to be available to the client PC 8, and in response, the GUI unit 81 of the client PC 8 displays the list of functions to be available by the version upgrade on the display device 208. Thus, the user can know the existence of the latest version, and in addition, the list of functions to be available.

<<Method for Obtaining Latest Version of Client Software>>

Although it has been described that the latest version of the client software is registered in the function list storage unit 402, the electronic whiteboard 2 may confirm the latest version of the client software appropriately as follows.

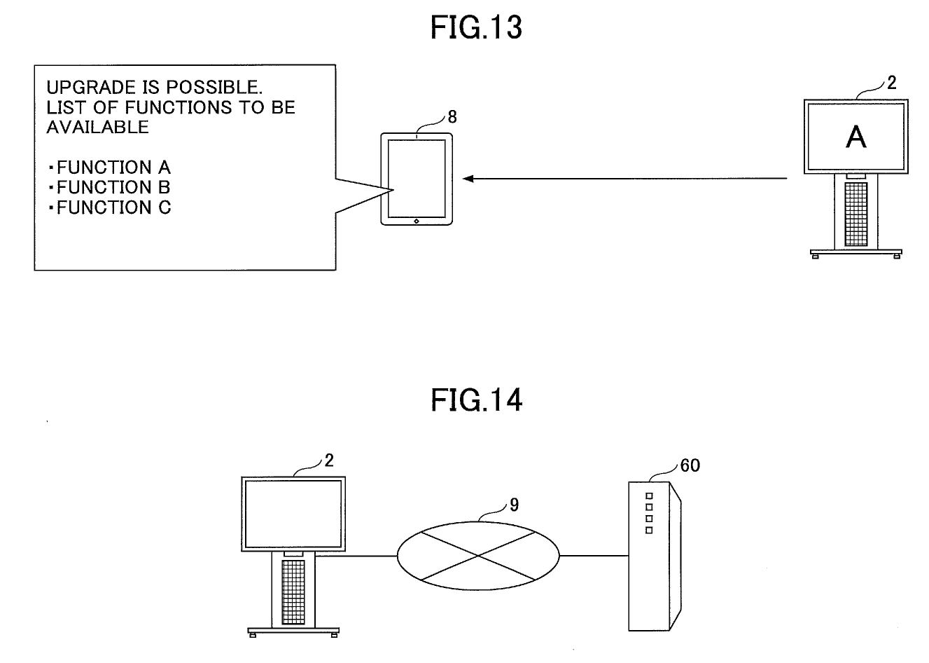

FIG. 14 is an example of a diagram illustrating a method for obtaining the latest version of the client software by the electronic whiteboard 2. The electronic whiteboard 2 is connected with the program distribution server 60 via the communication network 9. The program distribution server 60 is a server to distribute programs to the client PC 8 and the electronic whiteboard 2, storing the latest versions of the client software and the electronic whiteboard software.

The electronic whiteboard 2 has the IP address and the like of the program distribution server 60 registered, with which a query is made about the latest version of the client software and functions of the latest version, or the latest version of the client software is downloaded (to provide the client software from the electronic whiteboard 2 to the client PC 8). Therefore, the electronic whiteboard 2 can discretionally obtain the latest version of the client software and the functions. The electronic whiteboard 2 can register the obtained information in the function list storage unit 402.

The function comparison unit 47 makes a query to the program distribution server 60, or reads the functions of the latest version of the client software from the lists of functions, to obtain the functions to be available with the latest version of the client software, and to generate the list.

<Steps for Displaying List of Functions>

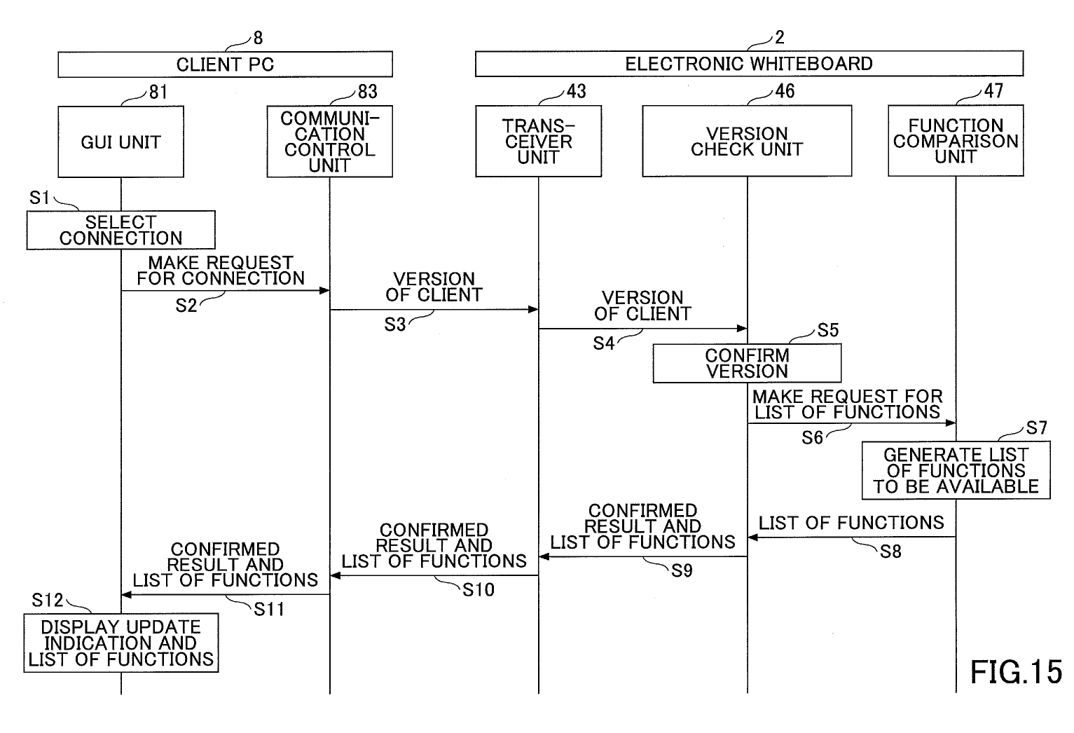

FIG. 15 is an example of a sequence chart illustrating steps for displaying a list of functions when the client PC 8 communicates with the electronic whiteboard 2. Note that since the process is similar to Steps S1 to S5, different points from FIG. 9 will be mainly described with FIG. 15.

Step S5: The version check unit 46 of the electronic whiteboard 2 confirms the versions. The method for confirmation is the same as in FIG. 9. At this Step S5, the version check unit 46 determines whether the version of the client software is the latest version. This is because if it is already the latest version, no version upgrade is required. If the version of the client software is already the latest, Steps S6 and after in FIG. 15 are not executed, but instead, Steps S6 and after in FIG. 9 are executed. In this case, at Step S9 in FIG. 9, the confirmed result is indicated to the client PC 8, or the communication control unit 83 starts receiving the compressed video 23 and the like.

Step S6: If the latest version exists, the version check unit 46 makes a request for the list of functions to the function comparison unit 47.

Step S7: The function comparison unit 47 of the electronic whiteboard 2 generates the list of functions to be available after the version upgrade. As described with FIG. 11, functions are compared between the current version of the electronic whiteboard software and the latest version of the client software, and a list of available functions is created.

Step S8: The function comparison unit 47 indicates the list of functions to be available to the version check unit 46.

Step S9: The version check unit 46 indicates the confirmed result and the list of functions to be available to the transceiver unit 43.

Step S10: The transmitter unit 43b of the electronic whiteboard 2 transmits the confirmed result and the list of functions to be available to the client PC 8.

Step S11: The communication control unit 83 of the client PC 8 receives the confirmed result and the list of functions to be available, and indicates the confirmed result and the list of functions to be available to the GUI unit 81 of the client PC 8.

Step S12: Thus, the GUI unit 81 of the client PC 8 displays an update indication along with the list of functions to be available.

Note that if the latest version of the client software exists, the user can upgrade the version, not only for a case where the confirmed result indicates no correspondence or a partial correspondence, but also for a case where the confirmed result indicates a correspondence. Therefore, whether to display the list of functions to be available is determined depending on whether the latest version of the client software exists, and hence, the list can be displayed regardless of the confirmed result.

Also, at Step S5, instead of the existence of the latest version of the client software, it may be determined whether a version of the client software exists that is newer than the current version of the client software installed on the client PC 8. This is because the user may want to upgrade to a version whatever newer than the current version of the client software.

As described above, the image processing system 1 according to the embodiment displays the list of functions to be available with the latest version when confirming the version. Therefore, it is easy for the user to determine whether to upgrade the version.

<Functions Available with the Current Version>

Which functions becomes newly available when a version upgrade is made to the latest software on the client PC 8, also depends on the version of the software that has already installed on the client PC 8. Thereupon, the client PC 8 may display functions available with the current version of the client software, in addition to functions available with the latest version.

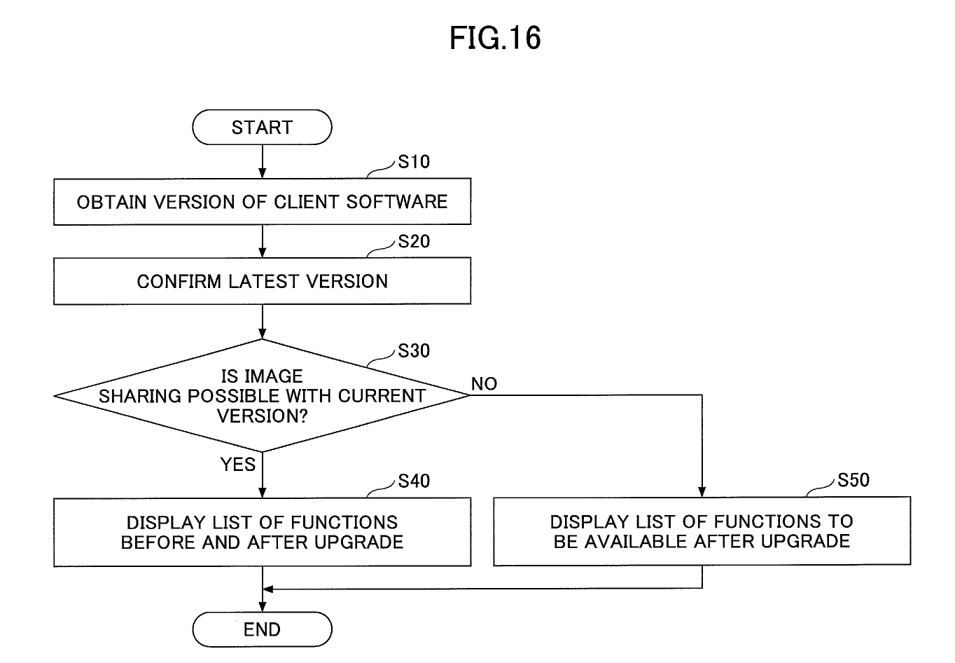

FIG. 16 is a diagram illustrating a flowchart for presenting a list of functions available with the current version of the client software, in addition to a list of functions to be available with the latest version. A process of FIG. 16 is executed as an alternative of Step S7 in FIG. 15.

The function comparison unit 47 obtains the current version of the client software (Step S10).

Next, the function comparison unit 47 obtains the latest version of the client software (Step S20).

Then, before obtaining a list of functions available with the latest version, the function comparison unit 47 determines whether the image sharing is possible between the current version of the client software and the electronic whiteboard 2 (Step S30).

If the determination at Step S30 is NO, the image sharing is not possible, and hence, there is no available function. Therefore, the function comparison unit 47 generates only a list of functions to be available after the version upgrade as in the sequence in FIG. 15 (Step S50).

If the determination at Step S30 is YES, the function comparison unit 47 generates not only a list of functions to be available after the version upgrade, but also a list of functions available with the current version (Step S40). The list of functions available with the current version is created by the method illustrated in FIG. 11 or FIG. 12, specifically as follows.

(1) The function comparison unit 47 generates a list of functions available with the current version of the electronic whiteboard software.
(2) The function comparison unit 47 obtains functions available with the current version of the client software, and generates the list.
(3) The function comparison unit 47 compares the two lists, and generates a list of functions available with both of the versions.

Therefore, if a connection is possible with the current version of the client software, differences of functions before and after the version upgrade can be presented for the user. Thus, it is easy for the user to determine whether to upgrade the version.

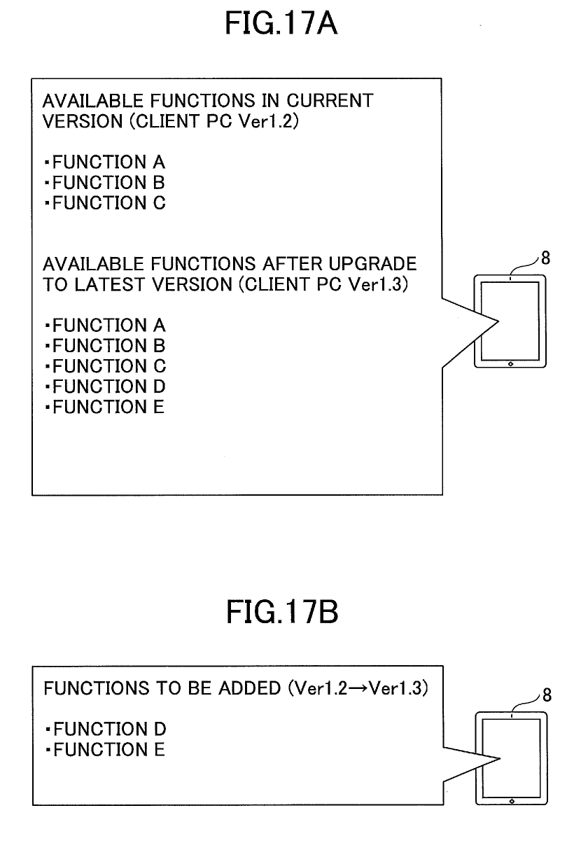

FIG. 17A is a diagram illustrating a list of functions displayed by the client PC 8 at Step S40 in FIG. 16. In FIG. 17A, assume that the version of the client software is 1.2, and the latest version is 1.3. Displayed in the figure are a list of functions available with the current version, and a list of functions available with the latest version. The user referring to the list of functions available with the current version (an example of second available functions), may determine not to upgrade the version if a desired function is already available. Also, the user referring to the list of functions available with the latest version, may determine to upgrade the version if a desired function is to be available.

Therefore, by having the client PC 8 present to the user the difference of functions between before and after a version upgrade, the user can select whether to upgrade the version.

The current version and the list of functions available with the current version, and the latest version and the list of functions available with the latest version in FIG. 17A may be displayed along with the list of functions in FIG. 14.

Also, functions available before and after a version upgrade may be further compared, to display additional functions only. FIG. 17B is an example of a diagram illustrating additional functions displayed on the display device 208 of the client PC 8. The function comparison unit 47 generates a list of different functions between the list of functions available with the current version, and the list of functions available with the latest version.

In FIG. 17B, functions D and E are displayed as additional different functions before and after the version upgrade. Thus, the user can grasp functions added with the version upgrade to the latest version at a glance.

Note that only functions D and E may be displayed as additional functions in FIG. 17B, or functions D and E may be displayed along with the current version and the list of functions available with the current version, and the latest version and the list of functions available with the latest version in FIG. 17A.

### OTHER EMBODIMENTS

As above, most preferable embodiments have been described. Note that the present invention is not limited to these embodiments, but various variations and modifications may be made without departing from the scope of the present invention.

For example, the client PC 8 may execute version checking. In this case, the client PC 8 includes a version determination condition storage unit, and obtains the version of the electronic whiteboard software from the electronic whiteboard 2.

Also, the client PC 8 may generate the list of functions. In this case, the electronic whiteboard 2 includes a function list storage unit, and obtains the version of the electronic whiteboard software from the electronic whiteboard 2.

In the embodiments, the electronic whiteboard 2 and the client PC are taken as an example for describing whether the versions of the software correspond to each other, but the client PC may communicate with a device other than the electronic whiteboard 2. For example, the embodiments are applicable to communication with a projector, an image forming apparatus (a copy machine, a printer, a scanner, an MFP (Multi-Function Peripherals), etc.), a video-conference terminal, and the like.

Also, the versions of the software have been described in the embodiments, but the embodiments are applicable to versions of information relating to functions other than the versions of software. For example, the versions of setting information with respect to the electronic whiteboard 2 and the client PC 8 may be considered. The setting information means settings about operations of the electronic whiteboard 2. For example, the setting information may include settings to have the electronic whiteboard 2 operate appropriately, settings to permit or limit operations of the electronic whiteboard 2, settings to turn on and off respective functions, and settings to communicate with the Internet and other devices via a network. Assuming that available functions are different depending on versions of setting information, by considering the versions of the setting information on the electronic whiteboard 2 and the client PC 8, it is possible to present functions available on the client PC 8 by a version upgrade of the setting information.

Also, the example configuration as illustrated in FIG. 6 includes functional units partitioned based on main functions, to make it easy to understand processes executed by the electronic whiteboard 2 and the client PC 8. Note that the present invention is not limited by such specific partitioning of functional units and their names. The processes by the electronic whiteboard 2 and the client PC 8 may be further partitioned into more functional units depending on contents of processing. Also, partitioning may be done such that each functional unit includes further more contents of processing.

Also, one or more storage units in the storage unit 400 in FIG. 6 may exist on a network.

Note that the client software is an example of first software, the electronic whiteboard software is an example of second software, the receiver unit 43a is an example of a receiver unit, the list of functions is an example of function information, the list of functions corresponding to the latest version of the client software is an example of first functions, the list of functions corresponding to the current version of the electronic whiteboard software is an example of second functions, the function comparison unit 47 is an example of a function identification unit, and the transmitter unit 43b is an example of a transmitter unit.

The version determination conditions are an example of correspondence information, the version check unit 46 is an example of a determination unit, and the update indication is an example of information prompting a version upgrade. The list of functions available with the current version of the client software is an example of third functions. The communication control unit 83 is an example of an obtainment unit, and the GUI unit 81 is an example of a display unit. The image processing system 1 is an example of an information processing system.

### RELATED-ART DOCUMENTS

### Patent Documents

[Patent Document 1] Japanese Unexamined Patent Application Publication No. 2015-528943

The present application claims priority under 35 U.S.C. §119 of Japanese Patent Application No. 2015-244315 filed on Dec. 15, 2015, the entire contents of which are hereby incorporated by reference.

What is claimed is:

1. An information processing apparatus that executes second software capable of communicating with first software, and communicates with an information terminal that executes the first software, the information processing apparatus comprising:
a receiver unit configured to receive version information of the first software from the information terminal;
a function identification unit configured, in a case where the first software having newer version information exists, that is newer than the first software having the version information received by the receiver unit, to refer to function information in which one or more available functions are associated with the version information of the first software and the second software, respectively, so as to obtain one or more first functions available with the first software after a version upgrade, and one or more second functions available with a current version information of the second software, and to identify available functions commonly with the first functions and the second functions; and
a transmitter unit configured to transmit the available functions identified by the function identification unit to the information terminal.

2. The information processing apparatus according to claim 1, wherein the function identification unit refers to the function information so as to obtain one or more third functions available with a current version of the first software, and to identify one or more second available functions that are common between the third functions and the second functions,
wherein the transmitter unit transmits the second available functions to the information terminal.

3. The information processing apparatus according to claim 2, wherein the function identification unit identifies different functions between the first functions and the third functions,
wherein the transmitter unit transmits the different functions to the information terminal.

4. The information processing apparatus according to claim 1, wherein latest version information of the first software in the function information is the version information of the first software after the version upgrade,
wherein the function identification unit refers to the function information, so as identify the first functions available with the first software after the version upgrade to the latest version information.

5. The information processing apparatus according to claim 1, further comprising:
a determination unit configured, when the receiver unit receives the version information of the first software, to refer to correspondence information in which whether the first software corresponds to the second software with respect to a combination of the version information of the first software and the version information of the second software, is registered, and
to determine whether the first software corresponds to the second software based on the version information of the first software received by the receiver unit, and the current version information of the second software on the information processing apparatus,
wherein in a case where the determination unit has determined that the first software does not correspond to the second software, the transmitter unit transmits information prompting the version upgrade of the first software to the information terminal.

6. The information processing apparatus according to claim 5, wherein it is registered in the correspondence information that the first software corresponds to the second software with respect to the combination of the version information of the first software and the version information of the second software if the first software includes more functions than the second software,
wherein once the determination unit has determined that the first software corresponds to the second software, the information processing apparatus starts a process for image sharing with the information terminal.

7. The information processing apparatus according to claim 6, wherein a function in the first software including the more functions than the second software, is a function about a command to indicate content of an operation on the information terminal to the information processing apparatus, or content of an operation on the information processing apparatus to the information terminal.

8. A method for processing information executed by an information processing apparatus that executes second software capable of communicating with first software, and communicates with an information terminal that executes the first software, the method comprising:
receiving version information of the first software from the information terminal;
referring, in a case where the first software having newer version information exists, that is newer than the first software having the version information received by the receiver unit, to function information in which one or more available functions are associated with the version information of the first software and the second software, respectively, so as to obtain one or more first functions available with the first software after a version upgrade, and one or more second functions available with a current version information of the second software, and to identify available functions commonly with the first functions and the second functions; and
transmitting the available functions identified by the referring to the information terminal.

9. An information processing system comprising:
an information terminal configured to execute first software; and
an information processing apparatus configured to execute second software capable of communicating with the first software, and to communicate with the information terminal,
wherein the information processing apparatus include
a receiver unit configured to receive version information of the first software from the information terminal,
a function identification unit configured, in a case where the first software having newer version information exists, that is newer than the first software having the version information received by the receiver unit, to refer to function information in which one or more available functions are associated with the version information of the first software and the second software, respectively, so as to obtain one or more first functions available with the first software after a version upgrade, and one or more second functions available with a current version information of the second software, and to identify available functions commonly with the first functions and the second functions, and
a transmitter unit configured to transmit the available functions identified by the function identification unit to the information terminal,
wherein the information terminal includes
an obtainment unit configured to obtain the available functions, and
a display unit configured to display the available functions obtained by the obtainment unit on a display device.
